(19) United States
(12) Patent Application Publication
(10) Pub. No.: US 2024/0166532 A1
(43) Pub. Date: May 23, 2024

(54) PROCESS FOR MAKING PARTICULATE OXYHYDROXIDE OR OXIDES

(71) Applicant: BASF SE, Ludwigshafen am Rhein (DE)

(72) Inventors: Thorsten BEIERLING, Ludwigshafen (DE); Daniela KOEHLER, Ludwigshafen (DE); Benjamin Johannes Herbert BERGNER, Ludwigshafen (DE); Christoph ERK, Ludwigshafen (DE)

(21) Appl. No.: 18/550,378

(22) PCT Filed: Mar. 21, 2022
(86) PCT No.: PCT/EP22/57294

§ 371 Date: Sep. 13, 2023

(30) Foreign Application Priority Data
Mar. 31, 2021 (EP) 21166132.7

(51) Int. Cl. C01G 53/00; H01M 4/505; H01M 4/525; H01M 10/0525

(52) U.S. Cl. CPC C01G 53/44; C01G 53/006; C01G 53/66; H01M 4/505; H01M 4/525; H01M 10/0525; C01P 2002/60; C01P 2004/53; C01P 2006/12; C01P 2006/40

(57) ABSTRACT

Disclosed herein is a process for making a particulate oxyhydroxide or oxide of TM with a bimodal particles diameter distribution where TM represents metals, and where TM includes nickel and at least one metal is selected from the group consisting of cobalt and manganese.

The present invention is directed towards a process for making a particulate oxyhydroxide or oxide of TM with a bimodal particles diameter distribution wherein TM represents metals, and wherein TM comprises nickel and at least one metal selected from cobalt and manganese. Said process comprises the steps of:
(a) providing an aqueous solution (α1) containing a water-soluble salt of Ni and, optionally, at least one transition metal other than nickel, and an aqueous solution (β1) containing an alkali metal hydroxide and, optionally, an aqueous solution (γ1) containing a complexing agent selected from ammonia, glycine, tartrate, citrate, and oxalate,
(b) combining solution (α1) and solution (β1) and, if applicable, solution (γ1), at a pH value in the range of from 10.0 to 14.0, thereby creating particles of a hydroxide of TM,
(c) removing the particles from step (b) from the liquid by a solid-liquid separation method,
(d) providing an aqueous solution (α2) containing a water-soluble salt of Ni and, optionally, at least one transition metal other than nickel, and an aqueous solution (β2) containing an alkali metal hydroxide and, optionally, an aqueous solution (γ2) containing a complexing agent selected from ammonia, glycine, tartrate, citrate, and oxalate,
(e) combining solution (α2) and solution (β2) and, if applicable, solution (γ2), at a pH value in the range of from 10.0 to 14.0, thereby creating particles of a hydroxide of TM, with at least one process parameter different from step (b), said process parameter being selected from pH value, temperature, stirring parameters, complexing agent, residence time, and reactor geometry,
(f) removing the particles from step (e) from the liquid by a solid-liquid separation method, and
(g) combining the particles from step (c) and step (f), before or after or during a treatment at 80 to 750° C. in the absence of a lithium compound,

wherein steps (b) and (e) are performed in a continuous mode, and wherein at least one of solutions (α1) and (α2) contains a metal selected from cobalt and manganese.

Lithiated transition metal oxides are currently being used as electrode active materials for lithium-ion batteries. Extensive research and developmental work have been performed in the past years to improve properties like charge density, specific energy, but also other properties like the reduced cycle life and capacity loss that may adversely affect the lifetime or applicability of a lithium-ion battery. Additional effort has been made to improve manufacturing methods.

In a typical process for making cathode materials for lithium-ion batteries, first a so-called pre cursor is being formed by co-precipitating the transition metals preferably as hydroxides that may or may not be basic, for example oxyhydroxides. Hydroxides may be pre-calcined and turned into oxides or oxyhydroxides, or they are directly mixed with a source of lithium such as, but not limited to LiOH, Li₂O, Li₂O₂ or Li₂CO₃ and calcined (fired) at high temperatures. Source of lithium can be employed as hydrate(s) or in dehydrated form. The calcination—or firing—often also referred to as thermal treatment or heat treatment of the precursor—is usually carried out at temperatures in the range of from 600 to 1,000° C. During the thermal treatment a solid-state reaction takes place, and the electrode active material is formed. The thermal treatment is performed in the heating zone of an oven or kiln.

A typical class of cathode active materials delivering high energy density contains a high amount of Ni (Ni-rich), for example at least 80 mol-%, referring to the content of non-lithium metals. However, the energy density still needs improvement.

To a major extent, properties of the precursor translate into properties of the respective electrode active material, such as particle size distribution, content of the respective transition metals and more. It is therefore possible to influence the properties of electrode active materials by steering the properties of the precursor.

It was therefore an objective of the present invention to provide electrode active materials with high energy density and a simple process for manufacturing them.

It has been suggested to make blends from cathode active materials with different particle diameters, for example bimodal blends, see, e.g., US 2011/0240913. However, the suggested process is tedious.

Accordingly, the process defined at the outset has been found, hereinafter also referred to as inventive process or process according to the present invention. The inventive process is a process for making a particulate oxyhydroxide or oxide of TM. Said particulate oxyhydroxide or oxide then serves as a precursor for electrode active materials, and it may therefore also be referred to as precursor.

The resultant oxyhydroxide or oxide of TM is in particulate form, and with a bimodal number based particle diameter distribution. The particles size distribution may be determined by light scattering or LASER diffraction or electroacoustic spectroscopy, LASER diffraction being preferred. One maximum in the number based particle diameter distribution is preferably in the range of from 0.8 to 2 μm and the other in the range of from 2.1 to 4 μm. In this context, particle diameters refer to the diameter of the secondary particles.

In one embodiment of the present invention, the particle shape of the secondary particles of the resultant precursors is spheroidal, that are particles that have a spherical shape. Spherical spheroidal shall include not just those which are exactly spherical but also those particles in which the maximum and minimum diameter of at least 90% (number average) of a representative sample differ by not more than 10%.

In one embodiment of the present invention, the resultant precursors are comprised of secondary particles that are agglomerates of primary particles.

In one embodiment of the present invention the specific surface (BET) of the resultant precursors is in the range of from 2 to 120 m²/g, determined by nitrogen adsorption, for example in accordance with to DIN-ISO 9277:2003-05.

The precursor is an oxyhydroxide or oxide of TM wherein TM comprises Ni and at least one transition metal selected from Co and Mn, and, optionally, at least one further metal selected from Ti, Zr, Mo, W, Al, Mg, Nb, and Ta.

Oxides of TM may contain residual hydroxyl groups or carbonate groups, for example in the range of from 100 to 1,000 ppm (by mass), determined by differential thermogravimetric methods (“DSC”) as weight loss at a temperature in the range of from 180 to 450° C.

In one embodiment of the present invention, TM is a combination of metals according to general formula (I)

(NiₐCo_{b}Mn_{c})_{1-d}M_{d} (I)

with
a being in the range of from 0.6 to 0.98, preferably from 0.8 to 0.95, more preferably from 0.83 to 0.92,
b being in the range of from 0.025 to 0.2, preferably from 0.025 to 0.15,
c being in the range of from zero to 0.3, preferably from zero to 0.15,
and
d being in the range of from zero to 0.1, preferably from zero to 0.05,
M is selected from Al, Ti, Zr, Mo, W, Al, Mg, Nb, and Ta,

a+b+c=1.

TM may contain traces of further metal ions, for example traces of ubiquitous metals such as sodium, calcium or zinc, as impurities but such traces will not be taken into account in the description of the present invention. Traces in this context will mean amounts of 0.05 mol-% or less, referring to the total metal content of TM.

The inventive process comprises the following steps (a) and (b) and (c) and (d) and (e) and (f) and (g), hereinafter also referred to as step (a) and step (b) and step (c) and step (d) and step (e) and step (f) and step (g), or briefly as (a) or (b) or (c) or (d) or (e) or (f) or (g), respectively. The inventive process will be described in more detail below.

Step (a) includes providing aqueous solution (α1) containing water-soluble salts of Ni and of at least one transition metal selected from Co and Mn, and, optionally, at least one further metal selected from Ti, Zr, Mo, W, Al, Mg, Nb, and Ta, and an aqueous solution (β1) containing an alkali metal hydroxide and, optionally, an aqueous solution (γ1) containing a complexing agent selected from ammonia, glycine, tartrate, citrate, and oxalate.

The term water-soluble salts of cobalt and nickel or manganese or of metals other than nickel and cobalt and manganese refers to salts that exhibit a solubility in distilled water at 25° C. of 25 g/l or more, the amount of salt being determined under omission of crystal water and of water stemming from aquo complexes. Water-soluble salts of nickel and cobalt and manganese may preferably be the respective water-soluble salts of Ni²⁺ and Co²⁺ and Mn²⁺. Examples of water-soluble salts of nickel and cobalt are the sulfates, the nitrates, the acetates and the halides, especially chlorides. Preferred are nitrates and sulfates, of which the sulfates are more preferred.

Said aqueous solution (α1) preferably contains Ni and further metal(s) in the relative concentration that is intended as TM of the precursor, or in one of the fractions of the precursor.

Said aqueous solution (α1) preferably contains Ni and, optionally, further metal(s) in a total con centration of from 0.5 to 2.2 mol/l.

Solution (α1) may have a pH value in the range of from 2 to 5. In embodiments wherein higher pH values are desired, ammonia may be added to solution (α1). In other embodiments, no ammonia is added to solution (α1).

In step (a), in addition an aqueous solution of alkali metal hydroxide is provided, hereinafter also referred to as solution (β1). An example of alkali metal hydroxides is lithium hydroxide, preferred is potassium hydroxide and a combination of sodium and potassium hydroxide, and even more preferred is sodium hydroxide.

In embodiments wherein solution (β1) contains alkali metal hydroxide, said solution (β1) may additionally contain some amount of carbonate, e.g., 0.1 to 2% by weight, referring to the respective amount of alkali metal hydroxide, added deliberately or by aging of the solution or the respective alkali metal hydroxide.

Solution (β1) may have a concentration of alkali metal hydroxide in the range from 0.1 to 12 mol/l, preferably 6 to 10 mol/l.

The pH value of solution (β1) is preferably 13 or higher, for example 14.5. In the context of the present invention, pH values are determined at 23° C. unless specifically noted otherwise.

In the inventive process, it is preferred to use ammonia. Solution (γ1)—if applicable—contains a complexing agent selected from ammonia, glycine, tartrate, citrate, and oxalate. In the context of the present invention, the term glycine includes the compound glycine and its alkali metal salts, for example the potassium or preferably the sodium salt. The terms tartrate and oxalate include the respective free acids and the mono- and dialkali metal salts, for example the mono- or di-potassium salts or the mono- or disodium salts or mixed sodium and potassium salts. The term “citrate” includes citric acid and its alkali metal salts, for example the mono- or di- or trisodium salts and the mono-, di- and tripotassium salts.

In one embodiment of the present invention, solution (γ1) has an ammonia concentration in the range of from 1 to 30% by weight.

In one embodiment of the present invention, solution (γ1) contains in the range of from 0.05 to 1.0 mol-%, referring to TM, of a complexing agent selected from glycine, tartrate, citrate, and oxalate, or their respective alkali metal salts.

Step (b) includes combining solution (α1) and solution (β1) and, if applicable, solution (γ1), at a pH value in the range of from 10.0 to 14.0, preferably 11 to 12.2, thereby creating particles of a hydroxide of TM. Said particles are slurried in an aqueous medium.

In one embodiment of the present invention, step (b) is performed at a temperature in the range from 10 to 85° C., preferably at temperatures in the range from 40 to 65° C.

In one embodiment of the present invention, step (b) is performed at a pressure in the range of from 500 mbar to 10 bar, preferably at ambient pressure.

Step (b) is performed in a continuous mode, for example in a plug flow reactor or in a cascade of two or more continuous stirred tank reactors, preferably, in a single continuous stirred tank reactor, for example in a continuous stirred tank reactor with an overflow system.

In one embodiment of the present invention, step (b) is performed in a continuous stirred tank reactor operated with an average residence time in the range of from 1 hour to 12 hours, preferably from 3 hours to 7 hours.

Step (c) includes removing the particles from step (b) from the liquid by a solid-liquid separation method. Examples of solid-liquid separation methods are decantation, filtration, or centrifugation, filtration being preferred, to obtain a particulate material. Subsequently to step (c), the particulate material from step (b) may then be dried, for example under vacuum or under air at a temperature in the range of from 80 to 140° C. In the course of the drying in the presence of air, some oxidation may be observed, especially in embodiments where TM contains manganese.

Step (d) includes providing aqueous solution (α2) containing water-soluble salts of Ni and of at least one transition metal selected from Co and Mn, and, optionally, at least one further metal selected from Ti, Zr, Mo, W, Al, Mg, Nb, and Ta, and an aqueous solution (β2) containing an alkali metal hydroxide and, optionally, an aqueous solution (γ2) containing ammonia.

In the context of the present invention, the term “a solution contains a metal” shall mean that such solution contains a salt of said metal.

Said aqueous solution (α2) preferably contains Ni and further metal(s) in the relative concentration that is intended as TM of the precursor, or in one of the fractions of the precursor.

Solution (α2) may have the same composition as solution (α1) or a different one.

Said aqueous solution (α2) preferably contains Ni and, optionally, further metal(s) in a total con centration of from 0.1 to 12 mol/l, preferably 6 to 10 mol/l.

Solution (α2) may have a pH value in the range of from 2 to 5. In embodiments wherein higher pH values are desired, ammonia may be added to solution (α2).

Said aqueous solution (α2) preferably contains Ni and, optionally, further metal(s) in a total con centration of from 0.5 to 2.2 mol/l.

In step (a), in addition an aqueous solution of alkali metal hydroxide is provided, hereinafter also referred to as solution (β2). Solution (β2) may have a concentration of alkali metal hydroxide in the range from 0.1 to 12 mol/l, preferably 6 to 10 mol/l.

The pH value of solution (β2) is preferably 13 or higher, for example 14.5.

In the inventive process, it is possible to use ammonia but to feed it separately as solution (γ2) or in solution (β2) or in solution (α2).

Solution (β2) may have the same composition as solution (β1) or a different one.

Solution (γ2) may have the same composition as solution (γ1) or a different one.

In one embodiment of the present invention, solution (γ2) has an ammonia concentration in the range of from 1 to 30% by weight.

In one embodiment of the present invention, solution (γ2) contains in the range of from 0.05 to 1.0 mol-%, referring to TM, of a complexing agent selected from glycine, tartrate, citrate, and oxalate, or their respective alkali metal salts.

Step (e) includes combining solution (α2) and solution (β2) and, if applicable, solution (γ2), at a pH value in the range of from 10.0 to 14.0, preferably 11 to 12.5, thereby creating particles of a hydroxide of TM. Said particles are slurried in an aqueous medium.

In one embodiment of the present invention, step (e) is performed at a temperature in the range from 10 to 85° C., preferably from 40 to 65° C. Steps (b) and (e) may be performed at different temperatures or the same.

In one embodiment of the present invention, step (e) is performed at a pressure in the range of from 500 mbar to 10 bar, preferably at ambient pressure.

Step (e) is performed in a continuous mode, for example in a plug flow reactor or in a cascade of two or more continuous stirred tank reactors, and step (e) preferably performed in a continuous stirred tank reactor, for example in a continuous stirred tank reactor with overflow system.

In one embodiment of the present invention, step (e) is performed in a continuous stirred tank reactor operated with an average residence time in the range of from 1 hour to 12 hours, preferably from 3 hours to 7 hours.

In step (e), at least one process parameter is different from the respective parameter in step (b), said process parameter being selected from pH value, duration, temperature, stirring parameters, complexing agent, residence time, and reactor geometry.

In one embodiment of the present invention, in steps (b) and (e) the pH value differs by at least 0.1 units, for example 0.2 to 4.0 units, preferably 0.2 to 1.5 units.

In one embodiment of the present invention, in steps (b) and (e) the duration—which is steered by the average residence time—differs by at least one hour, for example one to five hours, preferably one to three hours. Longer residence times lead—with other parameters being un changed—to larger particulate (oxy)hydroxides.

In one embodiment of the present invention, in steps (b) and (e) the temperature differs by at least 5° C., for example 5 to 20° C., preferably 5 to 10° C. Higher temperatures lead with other parameters being unchanged—to larger particulate (oxy)hydroxides.

In one embodiment of the present invention, in steps (b) and (e) the stirring parameters are different, for example stirring speed or different stirrer geometries, or a different average energy input.

In one embodiment of the present invention, in steps (b) and (e) different complexing agents are used, or in step (c), a complexing agent used but in step (e) there is none.

In one embodiment of the present invention, in steps (b) and (e) different reactor types, sizes or diameter to height ratio, are used, thus, different reactor geometries.

Step (f) includes removing the particles from step (e) from the liquid by a solid-liquid separation method. Examples solid-liquid separation methods are decantation, filtration, or by the means of a centrifuge, filtration being preferred, to obtain such precursor. Subsequently to step (f), the particles from step (e) may then be dried, for example under air at a temperature in the range of from 100 to 140° C. In the course of the drying, some oxidation may be observed, especially in embodiments where TM contains manganese.

At least one of solutions (α1) and (α2) contains a metal selected from cobalt and manganese, or both solutions (α1) and (α2) contain a metal selected from cobalt and manganese.

In one embodiment of the present invention, the compositions of solutions (α1) and (α2) are the same, that is, they contain the same metals and deviate from each other by less than 2 mol-%. In other embodiments, the compositions of solutions (α1) and (α2) are different from each other.

In embodiments where solutions (α1) and (α2) have different compositions, at least one further process parameter in steps (b) and (e) is different. Different shall mean that the difference be tween the relative concentrations of a metal such as nickel in differs at least by 3 mol-%, prefer ably 5 to 10 mol-%.

In a preferred embodiment of the present invention, the compositions of solutions (β1) and (β2) are the same.

Step (g) includes combining the particles from step (c) and step (f), before or after or during a treatment at 80 to 750° C. in the absence of a lithium compound, preferably 250 to 700° C.

Examples of suitable vessels for mixing before or after treatment at 80 to 750° C., are any types of mixers like pneumatic mixers, drum mixers, mixers with stirrers with a horizontal or vertical axis, free fall-mixers, plough-share mixers, or the like.

Said treatment in step (g) may be carried out in a rotary kiln, in a roller hearth kiln or in a fluidized bed.

In one embodiment of the present invention, said treatment in step (g) has a duration in the range of from 30 minutes to 10 hours, preferably 30 minutes to 5 hours, preferably 1 to 3 hours. In embodiments wherein step (g) is carried out in a rotary kiln, said residence time refers to the average residence time,

In one embodiment of the present invention, the treatment in step (g) is performed under an atmosphere selected from inert gas, air, oxygen-enriched or oxygen-depleted air or flue gases Preferred is an atmosphere that contains oxygen, for example air, oxygen-enriched air or pure oxygen.

If the treatment in step (g) is carried out in a rotary kiln, mixing and treatment at a temperature of from 80 to 750° C. may be carried out simultaneously.

In one embodiment of step (g), during the thermal treatment the atmosphere is exchanged, for example 10 times to 1,000 times per hour in order to remove humidity and, if applicable, carbon dioxide.

Although a pressure higher or lower than ambient pressure may be used ambient pressure is preferred in step (g).

In the context of step (g), the term “in the absence of a lithium compound” means that the thermal treatment is carried out in the presence of less than 3 mol-% of lithium, referring to TM, preferably less than 1 mol-% of lithium and even more preferably les than 0.5 mol-% of lithium compound, for example 0.001 to 0.5 mol-%. Such lithium compounds may be any lithium compounds usually employed for transferring a precursor to a cathode active material such as, but not limited to lithium hydroxide, lithium carbonate, lithium nitrate or lithium peroxide. Such lithium compound if present usually results from an impurity in the vessel in which step (g) is carried out.

An oxyhydroxide or oxide of TM is obtained that excellently serves as precursor for a cathode active material for lithium ion batteries. In case the temperature in step (g) exceeds 300° C. predominantly an oxide will be formed. For the purposes of the present invention, the term oxyhydroxide is not restricted to compounds with oxide and hydroxide anions in a molar ratio of 1:1 but to any compound of TM with a molar ratio of oxide to hydroxide in the range of from 10:1 to 1:10.

A further aspect of the present invention relates to particulate oxyhydroxides and oxides of TM with a bimodal particle diameter distribution, hereinafter also referred to as inventive precursors, wherein TM comprises nickel and at least one metal selected from cobalt and manganese, and wherein the number distribution of the particle diameter distribution of said oxyhydroxide or oxide has a first relative maximum of the particle diameter in the range of from 0.8 to 2 μm and a second relative maximum in the range of from 2.1 to 4 μm, and wherein the specific surface area (BET) and vertical primary crystallite size from X-ray measurement of the particles from the second relative maximum are 1.05 to 3 times higher compared to the particles from the first relative maximum, and wherein the particle diameter is obtained by dynamic laser scattering or electroacoustic spectroscopy. The second relative maximum refers to the maximum of particles with the higher average diameter. The first relative maximum then refers to the maximum of particles with the smaller average diameter.

For the purposes of the present invention, the term oxyhydroxide is not restricted to compounds with oxide and hydroxide anions in a molar ratio of 1:1 but to any compound of TM with a molar ratio of oxide to hydroxide in the range of from 10:1 to 1:10.

Preferably, said particulate oxyhydroxide or oxide has a span in the range of from 1 to 3, the span being calculated as (D90)−(D10) divided by (D50). Said span refers to the span of the entire material. (D10) refers to the median value of 10%, (D90) refers to a median value of 90%, and D50 refers to a median value of 50%, each referring to the volume-based particle diameter.

In one embodiment of the present invention, inventive precursors have a number based particle diameter distribution that corresponds to a superposition of the particle diameter distribution of two materials, one a relative maximum of the particle diameter in the range of from 0.8 to 2 μm and another relative maximum in the range of from 2.1 to 4 μm, and each of the materials having a span in the range of from 0.8 to 1.7.

In one embodiment of the present invention, inventive precursors have a particle diameter distribution that corresponds to a mixture of two materials wherein the two materials have essentially the same elemental composition. Essentially the same means in this context that the difference of mol-% of the key components are less than 1 mol %, referring to TM.

In one embodiment of the present invention, inventive precursors have a number based particle diameter distribution that corresponds to a mixture of two materials wherein the two materials have different elemental compositions, for example at least one metal differs by at least 1.5 mol-%, referring to TM. In a preferred embodiment, wherein particles in the second maximum have a higher content in nickel than the particles in the first maximum, for example by 5% or more.

In one embodiment of the present invention, inventive precursors are selected from oxyhydroxides and oxides of TM wherein TM is a combination of metals according to general formula (I)

(NiₐCo_{b}Mn_{c})_{1-d}M_{d} (I)

with
a being in the range of from 0.6 to 0.98, preferably from 0.8 to 0.95, more preferably from 0.83 to 0.92,
b being in the range of from 0.025 to 0.2, preferably from 0.025 to 0.15,
c being in the range of from zero to 0.3, preferably from zero to 0.15,
and
d being in the range of from zero to 0.1, preferably from zero to 0.05, and

a+b+c=1, and b+c>zero.

TM may contain traces of further metal ions, for example traces of ubiquitous metals such as sodium, calcium or zinc, as impurities but such traces will not be taken into account in the description of the present invention. Traces in this context will mean amounts of 0.05 mol-% or less, referring to the total metal content of TM.

The particles size distribution may be determined by light scattering or LASER diffraction or electroacoustic spectroscopy, LASER diffraction being preferred. One maximum in the particle diameter distribution is preferably in the range of from 0.8 to 2 μm and the other in the range of from 2.1 to 4 μm. In this context, particle diameters refer to the diameter of the secondary particles.

In one embodiment of the present invention, inventive precursors may contain residual hydroxyl groups or carbonate groups, for example in the range of from 100 to 1,000 ppm (by mass), determined by differential thermogravimetric methods (“DSC”) as weight loss at a temperature in the range of from 180 to 450° C.

In one embodiment of the present invention, the particle shape of the secondary particles of the inventive precursors is spheroidal, that are particles that have a spherical shape. Spherical spheroidal shall include not just those which are exactly spherical but also those particles in which the maximum and minimum diameter of at least 90% (number average) of a representative sample differ by not more than 10%.

In one embodiment of the present invention, the inventive precursors are comprised of secondary particles that are agglomerates of primary particles.

In one embodiment of the present invention the specific surface (BET) of the inventive precursors is in the range of from 2 to 120 m²/g, determined by nitrogen adsorption, for example in accordance with to DIN-ISO 9277:2003-05.

The inventive precursors may be obtained by the inventive process.

A further aspect of the present invention relates to the use of inventive precursors for the manufacture of an electrode active material for lithium ion batteries. Said precursor is then mixed with a source of lithium such as, but not limited to LiOH, Li₂O or Li₂O₂ or Li₂CO₃ and calcined (fired) at high temperatures, for example 600 to 1000° C.

The invention will be further illustrated by working examples and a drawing.

### General:

The drawing schematically displays a stirred tank reactor in which the manufacture of the exemplified precursor was performed, hereinafter Reactor 1. Reactor 1 was 50 L stirred vessel equipped with baffles and a cross-arm stirrer with a diameter of 0.21 m. RPM: revolutions per minute. All pH value measurements were performed outside Reactor 1 and at 23° C.

Powder X-ray Diffraction (PXRD) data was collected using a laboratory diffractometer (D8 Discover, Bruker AXS GmbH, Karlsruhe). The instrument was set up with a Molybdenum X-ray tube. The characteristic K-α radiation was monochromatized using a bent Germanium Johansson type primary monochromator. Data was collected in the Bragg-Brentano reflection geometry in a 26 range from 5.0 to 50°, applying a step size of 0.019°. A LYNXEYE area detector was utilized to collect the scattered X-ray signal.

For XRD measurements, the precursors were ground using an IKA Tube Mill and an MT40.100 disposable grinding chamber. The powder was placed in a sample holder and flattened using a glass plate.

Rietveld refinement analyses of the microstructures of the precursors were performed using DIFFRAC.TOPAS V6 software (BrukerAXS GmbH).

The BET surface may be determined by nitrogen adsorption after outgassing of the sample at 120° C. for 30 minutes or more and beyond this accordance with DIN ISO 9277:2010.

In the context of the present invention, average diameter values refer to the mass (or volume) distribution unless expressly noted otherwise.

### BRIEF DESCRIPTION OF THE DRAWINGS

FIG. 1:
A: Stirred vessel
B: Stirrer
C: Inner pipe of coaxial mixer
D: Outer pipe of coaxial mixer
E: Baffles
F: Engine for stirrers
The overflow system is not shown.

FIG. 2: The number-based particle size distribution of IP.1

FIG. 3: definition of lateral and vertical (primary) crystallite size. In this application, both terms are used interchangeably.

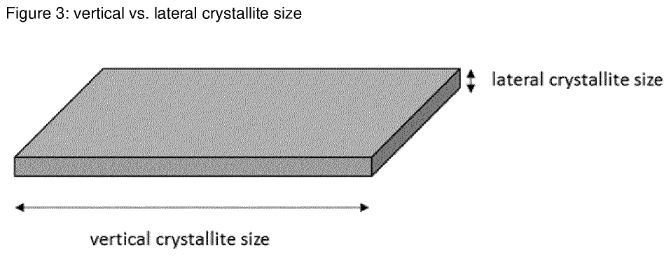

The coaxial mixer corresponds to the one of WO 2020/207901, FIG. 1. In step (b.1), the distance between the outlets of the two coaxially arranged pipes C and D was in the range of 15 mm. In step (e.1), the distance between the outlets of the two coaxially arranged pipes C and D was in the range of 40 mm.

Step (a.1): The following aqueous solutions were provided:

Solution (α1.1) was an aqueous solution of NiSO₄, CoSO₄ and MnSO₄ in a molar ratio 91:4.5:4.5, total metal concentration: 1.65 mol/kg

Solution (β1.1) was a 25% by weight aqueous solution of sodium hydroxide

Solution (γ1.1) was a 25% by weight aqueous ammonia solution

Reactor 1 was charged with 40 liters of water that was heated to 55° C. An amount of 929 g of solution (γ1.1) was added. Subsequently, the pH (measured at 23° C.) of the solution in Reactor 1 was adjusted with solution (β1.1) to 11.82. The stirrer element (pitch-blade turbine) was set to constant operation at 420 rpm (average input ˜12.6 W/l).

### Step (b.1):

Solution (α1.1), (β1.1) and (γ1.1) were simultaneously introduced into Reactor 1. The aqueous metal solution was introduced via the inner pipe C of the coaxial mixer while the aqueous sodium hydroxide and aqueous ammonia solution were introduced via the outer pipe D of the coaxial mixer. The molar ratio between ammonia and transition metal of solution (α1.1) was adjusted to 0.25. Precipitate formation was observed.

The sum of volume flows of solutions (α1.1), (β1.1) and (γ1.1) was set to adjust the mean residence time to 5 hours. The flow rate of solution (β1.1) was adjusted by a pH regulation circuit to keep the pH value in Reactor 1 at a constant value of 11.82±0.05. Reactor 1 was operated continuously keeping the liquid level in the vessel constant. A mixed hydroxide of Ni, Co and Mn was collected via free overflow from Reactor 1. The resulting slurry contained about 120 g/l mixed hydroxide of Ni, Co and Mn.

Step (c.1): The slurry from step (b.1) was filtered. The resulting filter cake was washed with deionized water and then with an aqueous solution of sodium hydroxide (1 kg of 25 wt % aqueous sodium hydroxide solution per kg of solid hydroxide), filtered and dried at 120° C. over 12 hours to obtain mixed oxyhydroxide TM-OOH.1-1. Mixed oxyhydroxide TM-OOH.1-1 had an average particle diameter (D50) of 6.4 μm volume distribution, a span of 1.54, a tap density of 1.93 g/l and a BET surface of 16.4 m²/g. Furthermore, the vertical primary crystallite size determined via X-Ray measurement amounted 6.4 nm.

Step (d.1): The following aqueous solutions were provided:

Solution (α2.1) was an aqueous solution of NiSO₄, CoSO₄ and MnSO₄ in a molar ratio 91:4.5:4.5, total metal concentration: 1.65 mol/kg

Solution (β2.1) was a 25% by weight aqueous solution of sodium hydroxide

Solution (γ2.1) was a 25% by weight aqueous ammonia solution

Reactor 1 was charged with 40 liters of water that was heated to 55° C. An amount of 1824.5 g solution (γ2.1) was added. Subsequently, the pH (measured at 23° C.) of the solution in Reactor 1 was adjusted with solution (β2.1) to 11.76±0.05. The stirrer element (pitch-blade turbine) was set to constant operation at 420 rpm (average input ˜12.6 W/l).

### Step (e.1):

Solution (α2.1), (β2.1) and (γ2.1) were simultaneously introduced into Reactor 1. The aqueous metal solution was introduced via the inner pipe C of the coaxial mixer while the aqueous sodium hydroxide and aqueous ammonia solution were introduced via the outer pipe D of the coaxial mixer. The molar ratio between ammonia and transition metal of solution (α2.1) was adjusted to 0.5. Precipitate formation was observed.

The sum of volume flows of solutions (α2.1), (β2.1) and (γ2.1) was set to adjust the mean residence time to 5 hours. The flow rate of solution (β2.1) was adjusted by a pH regulation circuit to keep the pH value in Reactor 1 at a constant value of 11.76±0.05. Reactor 1 was operated continuously keeping the liquid level in the vessel constant. A mixed hydroxide of Ni, Co and Mn was collected via free overflow from Reactor 1. The resulting slurry contained about 120 g/l mixed hydroxide of Ni, Co and Mn.

### Step (f.1):

The slurry from step (e.1) was filtered. The resulting filter cake was washed with deionized water and then with an aqueous solution of sodium hydroxide (1 kg of 25 wt % aqueous sodium hydroxide solution per kg of solid hydroxide) and filtered and dried at 120° C. over a period of 12 hours to obtain mixed hydroxide TM-OOH.1-2. Mixed oxyhydroxide TM-OOH.1-2 had an aver age particle diameter (D50) of 15.8 μm volume distribution, a span of 1.264, a tap density of 1.84 g/l and a BET surface of 25.3 m²/g. Furthermore, the vertical primary crystallite size determined via X-ray measurement amounted 10.7 nm.

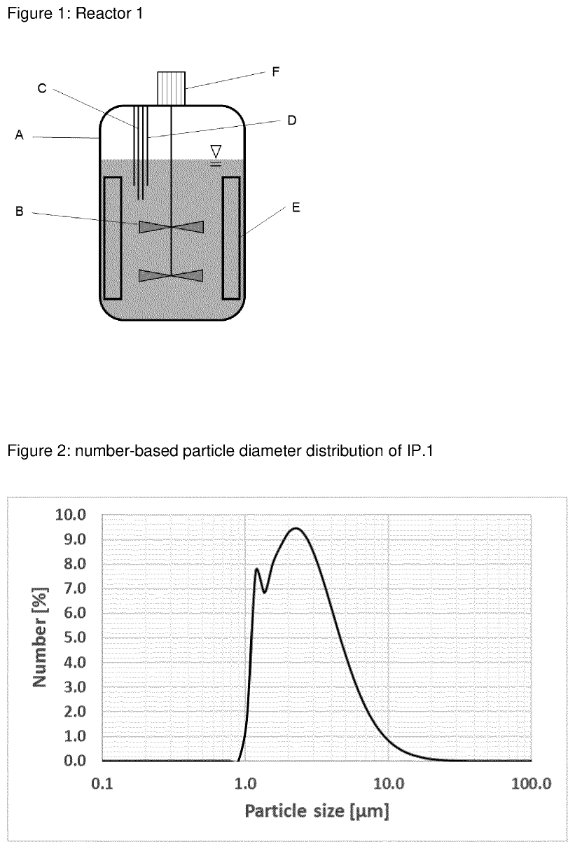

Step (g.1): The separately dried mixed oxyhydroxides TM-OOH.1-1 and TM-OOH1-2 were mixed in a mass ratio of 1:1. The particle size distribution was measured via laser diffraction method. The span based on the volume distribution amounted to 1.99. The number based particle size distribution had a bi-modal shape and showed a first relative maximum at 1.2 μm while the second relative maximum appears at 2.4 μm (see FIG. 2). Inventive precursor IP.1 was obtained. The BET surface area and the vertical primary crystallite size of the particles at second relative maximum was higher by a factor of 1.54 and 1.67 compared to the particles at first relative maximum.

IP.1 is perfectly suited for the production of cathode active material. After calcination with a source of lithium, a cathode active material with very high electrode density and very homogenous physical properties with respect to, e.g., crystallite size is obtained.

1. A process for making a particulate oxyhydroxide or oxide of TM with a bimodal particle diameter distribution, wherein TM is a combination of metals according to general formula (I)
(NiₐCo_{b}Mn_{c})_{1-d}M_{d} (I)
wherein:
a is in a range of from 0.6 to 0.98,
b is zero or in a range of from 0.025 to 0.2,
c is in a range of from zero to 0.3, and
d is in a range of from zero to 0.1,
M is selected from the group consisting of Mg, Al, Ti, Zr, Mo, W, Al, Mg, Nb, and Ta,
a+b+c=1, and b+c>zero,
wherein the process comprises the steps of:
(a) providing an aqueous solution (α1) comprising a water-soluble salt of Ni and, optionally, at least one transition metal other than nickel, and an aqueous solution (β1) comprising an alkali metal hydroxide and, optionally, an aqueous solution (γ1) comprising a complexing agent selected from the group consisting of ammonia, glycine, tartrate, citrate, and oxalate,
(b) combining solution (α1) and solution (β1) and, if applicable, solution (γ1), at a pH value in a range of from 10.0 to 14.0, thereby creating particles of a hydroxide of TM,
(c) removing the particles from step (b) from the liquid by a solid-liquid separation method,
(d) providing an aqueous solution (α2) comprising a water-soluble salt of Ni and, optionally, at least one transition metal other than nickel, and an aqueous solution (β2) comprising an alkali metal hydroxide and, optionally, an aqueous solution (γ2) comprising a complexing agent selected from the group consisting of ammonia, glycine, tartrate, citrate, and oxalate,
(e) combining solution (α2) and solution (β2) and, if applicable, solution (γ2), at a pH value in a range of from 10.0 to 14.0, thereby creating particles of a hydroxide of TM, with at least one process parameter different from step (b), the process parameter being selected from the group consisting of pH value, residence time, temperature, stirring parameters, complexing agent, and reactor geometry,
(f) removing the particles from step (e) from the liquid by a solid-liquid separation method, and
(g) combining the particles from step (c) and step (f), before or after or during a treatment in a range of from 80 to 750° C. in the absence of a lithium compound,
wherein steps (b) and (e) are performed in a continuous mode, and wherein at least one of solutions (α1) and (α2) comprises a metal selected from the group consisting of cobalt and manganese,
wherein in the resultant (oxy)hydroxide or oxide has one maximum in the number based particle diameter distribution in a range of from 0.8 to 2 μm and the other in a range of from 2.1 to 4 μm, and the specific surface area (BET) as determined by nitrogen adsorption, for example in accordance with to DIN-ISO 9277:2003-05 and the vertical primary crystallite size from X-Ray measurement of the particles from the second relative maximum are 1.05 to 3 times higher compared to the particles from the first relative maximum, and wherein the particle diameter is obtained by dynamic laser scattering or electroacoustic spectroscopy.

2. The process according to claim 1, wherein step (b) or step (e) is performed in a continuous stirred stank reactor.

3. The process according to claim 1, comprising the additional step (h) of combining the mixture of particles obtained from step (g) with a source of lithium and a subsequent thermal treatment.

4. The process according to claim 1, wherein the compositions of solutions (β1) and (β2) are the same.

5. The process according to claim 1, wherein the metal compositions of the particles obtained in steps (c) and (f) are the same.

6. The process according to claim 1, wherein the metal compositions of the particles obtained in steps (c) and (f) are different.

7. A particulate oxyhydroxide or oxide of TM with a bimodal particle diameter distribution wherein TM is a combination of metals according to general formula (I)
(NiₐCo_{b}Mn_{c})_{1-d}M_{d} (I)
wherein:
a is in a range of from 0.6 to 0.98,
b is zero or in a range of from 0.025 to 0.2,
c is in a range of from zero to 0.3, and
d is in a range of from zero to 0.1,
M is selected from the group consisting of Mg, Al, Ti, Zr, Mo, W, Al, Mg, Nb, and Ta,
a+b+c=1, and b+c>zero,
and wherein the number based particle diameter distribution displays a first relative maximum of the particle diameter in a range of from 0.8 to 2 μm and a second relative maximum in a range of from 2.1 to 4 μm, and wherein the specific surface area (BET) by determined by nitrogen adsorption in accordance with to DIN-ISO 9277:2003-05 and the vertical primary crystallite size from X-Ray measurement of the particles from the second relative maximum are 1.05 to 3 times higher compared to the particles from the first relative maximum, and wherein the particle diameter is obtained by dynamic laser scattering or electroacoustic spectroscopy.

8. The particulate oxyhydroxide or oxide according to claim 7, wherein the span of the entire material is in a range of from 1 to 3, the span being calculated as (D90)−(D10) divided by (D50), referring to the volume-based particle diameter.

9. The particulate oxyhydroxide or oxide according to claim 7, wherein the number based particle diameter distribution corresponds to a superposition of the particle diameter distribution of two materials, one a relative maximum of the particle diameter in a range of from 0.8 to 2 μm and another relative maximum in a range of from 2.1 to 4 μm, and each of the materials having a span in a range of from 0.8 to 1.7, the span referring to the volume based particle diameter.

10. The particulate oxyhydroxide or oxide according to claim 7, that corresponds to a mixture of two materials wherein the two materials have essentially the same elemental composition.

11. The particulate oxyhydroxide or oxide to claim 7, that corresponds to a mixture of two materials wherein the two materials have different elemental compositions.

12. The particulate oxyhydroxide or oxide according to claim 7, wherein the particles in the second maximum have a higher content in nickel than the particles in the first maximum.

13. A method of using a particulate oxyhydroxide or oxide according to claim 7, the method comprising using the particulate oxyhydroxide or oxide for the manufacture of an electrode active material for lithium ion batteries.
